(19) United States
(12) Patent Application Publication
(10) Pub. No.: US 2017/0144516 A1
(43) Pub. Date: May 25, 2017

(54) ACTIVE DOOR EDGE GUARD SYSTEM FOR A MOTOR VEHICLE

(71) Applicant: FORD GLOBAL TECHNOLOGIES, LLC, Dearborn, MI (US)

(72) Inventors: Donald P. Iacovoni, Plymouth, MI (US); Paul L. Heirtzler, JR., Northville, MI (US); Howard Paul Tsvi Linden, Southfield, MI (US)

(21) Appl. No.: 14/949,336

(22) Filed: Nov. 23, 2015

(51) Int. Cl. B60J 5/04; E06B 9/00

(52) U.S. Cl. CPC B60J 5/0493; E06B 9/00

(57) ABSTRACT

An active door edge guard system is provided for a motor vehicle. That system includes a door edge guard, an electronic actuator for displacing the door edge guard between the stowed position and the deployed position, a door motion sensor and a controller. The controller is responsive to the door motion sensor and is configured to activate the electronic actuator to deploy the door edge guard as the motor vehicle door is opened and stow the door edge guard as the motor vehicle door is closed.

### TECHNICAL FIELD

This document relates generally to the motor vehicle equipment field and, more particularly, to an active door edge guard system for a motor vehicle.

### BACKGROUND

It is desirable to protect the exterior painted surface of a motor vehicle from incurring chips, scratches, dents and the like during normal usage. One of the ways these issues often occur is when the door of the motor vehicle is opened and inadvertently contacts an adjacent vehicle or other object, resulting in damage to the paint finish of the outer edge of the door.

This document relates to a new and improved active door edge guard system that will protect the door edge from such damage which might occur due to contact/impact with nearby objects.

### SUMMARY

In accordance with the purposes and benefits described herein, an active door edge guard system is provided for a motor vehicle. That active door edge guard system comprises a door edge guard and an electronic actuator for displacing the door edge guard between a stowed position and a deployed position in which the door edge guard protects the edge of the door from contact or impact with nearby objects. The active door edge guard system further includes a door motion sensor and a controller responsive to the door motion sensor to activate the electronic actuator as needed to protect the edge of the motor vehicle door.

In one possible embodiment of the door edge guard system, the door motion sensor is a Hall effect sensor. That Hall effect sensor may be carried on the motor vehicle door where it functions to monitor a door check assembly of the motor vehicle door. In yet another possible embodiment, the door motion sensor is a proximity sensor that monitors the door check assembly for the motor vehicle door.

In another possible embodiment of the active door edge guard system, the door motion sensor is a dedicated accelerometer carried on the motor vehicle door. That dedicated accelerometer may be carried on a housing for the electronic actuator if desired.

In yet another possible embodiment of the active door edge guard system, the door motion sensor is an existing side door impact sensor of a motor vehicle safety system. Such a side door impact sensor may comprise an accelerometer.

In still another possible embodiment of the active door edge guard system, the door motion sensor is a door ajar sensor. That door ajar sensor may be a plunger.

In any of the embodiments of an active door edge guard system, the controller may be configured to activate the electronic actuator to deploy the door edge guard as the motor vehicle door is opened and stow the door edge guard as the motor vehicle door is closed. In one possible embodiment, the controller is configured to provide a time delay between the moment of receiving a door open signal and the activation of the actuator to displace the door edge guard into the deployed position.

In accordance with an additional aspect, a method is provided for protecting an edge of a motor vehicle door from damage due to contact/impact with another object when the door is opened. That method comprises the steps of monitoring, by door motion sensor, movement of said motor vehicle door between closed and opened positions and activating, by controller, an electronic actuator for displacing a door edge guard between a stowed position and a deployed position protecting the edge of the motor vehicle door.

The method may further include the step of monitoring a door check assembly of the motor vehicle door to verify movement of the motor vehicle door between the closed and opened positions. In one possible embodiment, that method includes using a Hall effect sensor to monitor movement of the motor vehicle door between the closed and open positions. In another possible embodiment, the method includes using an accelerometer to monitor movement of the motor vehicle door between the closed and opened positions. In yet another embodiment, the method includes using a plunger to monitor movement of the motor vehicle door between the closed and opened positions.

In the following description, there are shown and described several preferred embodiments of the active door edge guard system. As it should be realized, the active door edge guard system is capable of other, different embodiments and its several details are capable of modification in various, obvious aspects all without departing from the active door edge guard system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the active door edge guard system and together with the description serve to explain certain principles thereof. In the drawing figures:

FIG. 1 is a schematic block diagram of the active door edge guard system.

FIGS. 2A and 2B are schematic representations of the door edge guard in respective stowed and deployed positions.

FIG. 3A is a schematic elevational view of the door of the motor vehicle (outer panel removed) showing the relative position of the electronic actuator for the door edge guard, the edge of the motor vehicle door protected by the door edge guard and the door check for the motor vehicle door.

FIGS. 3B and 3C are detailed perspective views illustrating the position of a sensor for monitoring the door check arm to indicate when the motor vehicle door has been closed and opened.

FIG. 4 is a perspective illustration of an alternative embodiment wherein the door motion sensor is an accelerometer.

FIG. 5 is a perspective view of yet another alternative embodiment wherein the door motion sensor is a plunger that may be located on the motor vehicle frame on the hinge side of the body structure or on the opposite side of the door opening where the plunger engages the distal end of the door when the motor vehicle door is closed.

Reference will now be made in detail to the present preferred embodiments of the active door edge guard system, examples of which are illustrated in the accompanying drawing figures.

### DETAILED DESCRIPTION

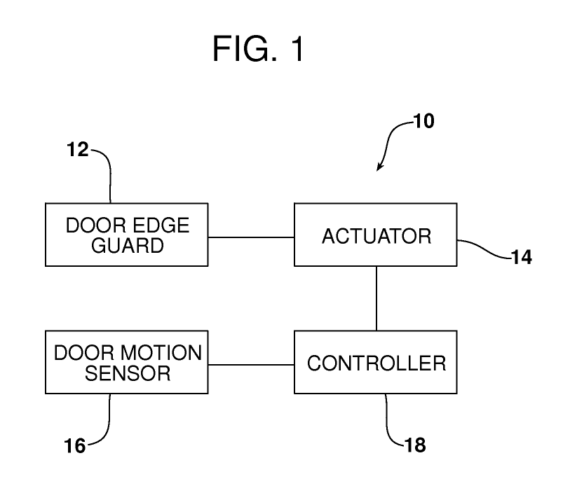

Reference is now made to FIG. 1 which is a schematic block diagram of the active door edge guard system 10. The active door edge guard system 10 includes a door edge guard 12, an electronic actuator 14, a door motion sensor 16 and a controller 18.

The controller 18 may comprise a computing device such as a dedicated microprocessor or an electronic control unit (ECU) operating in accordance with appropriate software instructions. The ECU may be part of another operating system of the motor vehicle such as an electronic door lock system or electronic door opening system or may even be the body control module (BCM). As is known in the art, the BCM performs a number of interior body electrically based functions including, for example, interior locking, remote key entry, interior light, exterior light, windshield wiper control and the like. In some embodiments the BCM may also function to control entertainment functions (e.g., radio, CD player and communications such as telephone and internet communications over a wireless network). In some embodiments the BCM is connected by a communication bus to other control modules that provide one or more of these additional functions.

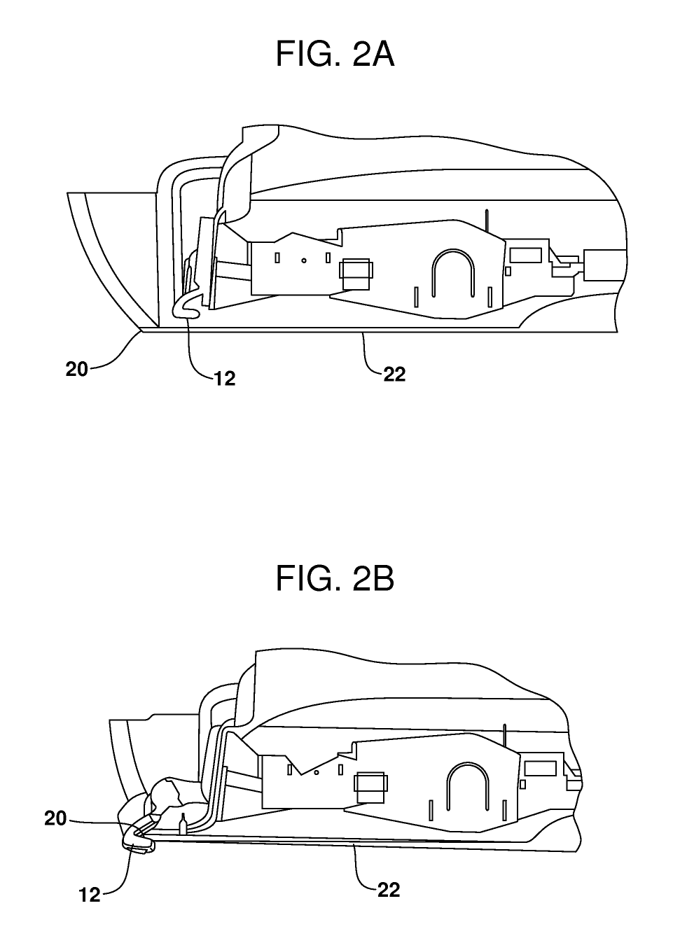

In any embodiment, the controller 18 is responsive to the door motion sensor 16 to activate the electronic actuator 14 as needed to protect an edge 20 of a motor vehicle door 22. More specifically, the electronic actuator 14 which may, for example, comprise a solenoid or the like, displaces the door edge guard 12 between a stowed position as illustrated in FIG. 2A and a deployed position, as illustrated in FIG. 2B, wherein the edge guard 12 nests over the edge 20 of the motor vehicle door 22 thereby preventing direct contact of the edge 20 with any object when the door is opened. As should be appreciated the door edge guard 12 may be made from an impact resistant plastic material with a shape adapted to overlie, nest with and protect the door edge 20.

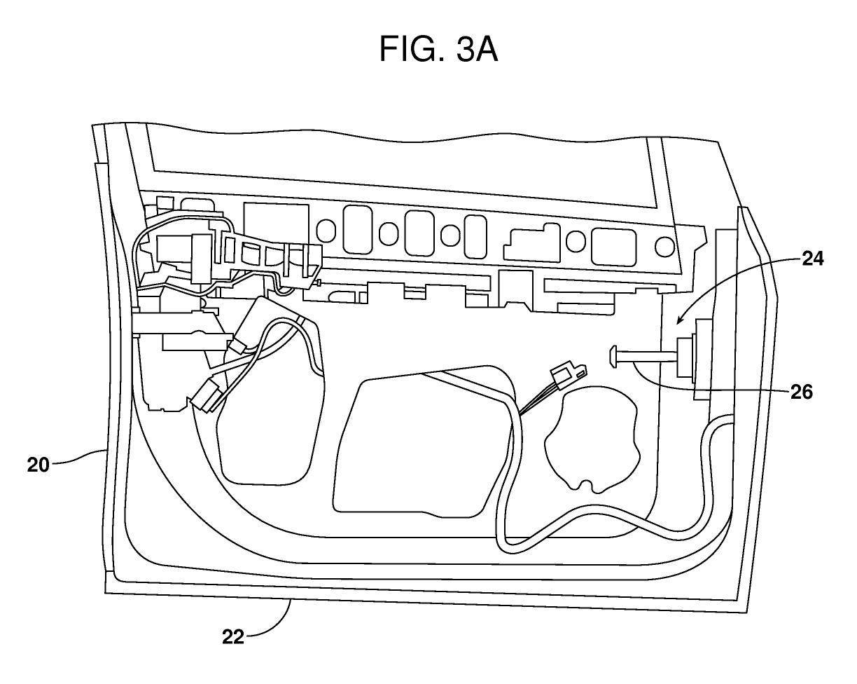

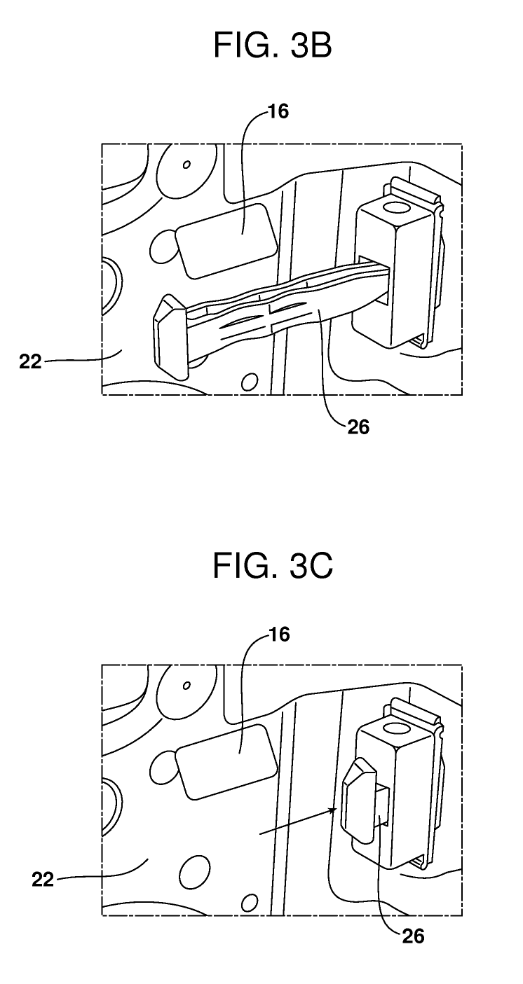

Reference is now made to FIGS. 3A-3C illustrating one possible embodiment of the active door edge guard system 10. As illustrated, the motor vehicle door 22 includes a door check assembly, generally designated by reference numeral 24, incorporating a door check arm 26 of a type known in the art that is fixed to the motor vehicle frame. In this embodiment, the door motion sensor 16 is carried on the motor vehicle door 22 adjacent the door check arm 26. As illustrated in FIG. 3B, when the motor vehicle door 22 is closed, the door check arm 26 extends into a position adjacent the sensor 16 where it is detected. In contrast, when the motor vehicle door 22 is opened, the door motion sensor 16 is moved with the door over the stationary door check arm 26. When the relative movement between the door motion sensor 16 and the door check arm 26 in this first direction is detected, an appropriate control signal is sent from the door motion sensor 16 to the controller 18.

In response to this signal, the controller 18 activates the electronic actuator 14 which then displaces the door edge guard 12 from the stowed position illustrated in FIG. 2A to the deployed position illustrated in FIG. 2B. In the deployed position the door edge guard 12 protects the door edge 20 from contact or impact with any object. In contrast, when the motor vehicle door 22 is closed, the door motion sensor 16 is moved in a reverse direction over the door check arm 26. When this reverse movement over the door check arm is detected, a signal is sent from the door motion sensor 16 to the controller 18. In response, the controller 18 activates the electronic actuator 14 to displace the door edge guard 12 back to the stowed position illustrated in FIG. 2A thereby allowing the door to close and latch freely. The door motion sensor 16 illustrated in FIGS. 3A-3C may comprise, for example, a Hall effect sensor or a proximity sensor.

In some embodiments, the controller 18 may be configured to provide a time delay between receiving the control signal indicating that the door 22 is being opened and sending the control signal to the actuator 14 to deploy the door edge guard 12. This is done to make certain that the door 22 is open sufficiently before the door edge guard 12 is deployed.

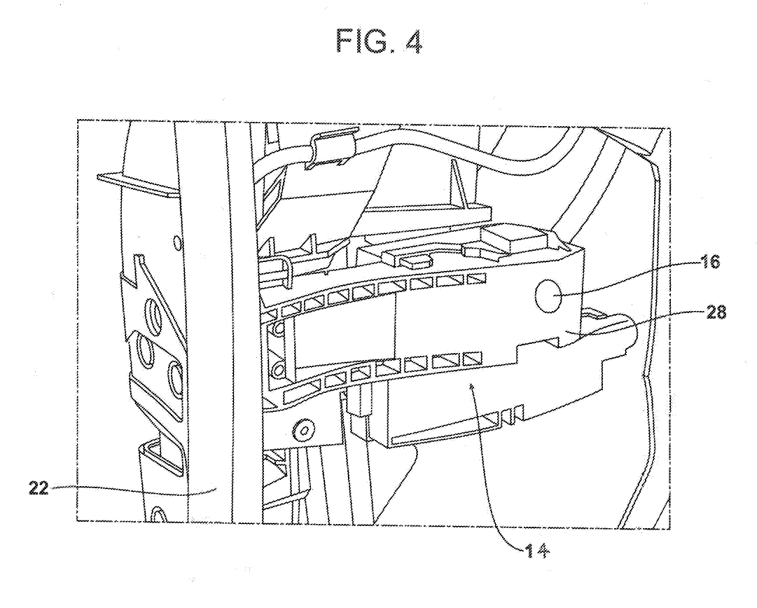

Reference is now made to FIG. 4 which illustrates an alternative embodiment of the active door edge guard system 10 wherein the door motion sensor 16 is an accelerometer that is mounted to or carried on the housing 28 of the electronic actuator 14. The accelerometer 16 illustrated in this embodiment may be a dedicated accelerometer for the active door edge guard system 10. It should be appreciated, however, that such a dedicated accelerometer does not necessarily have to be mounted to or carried on a housing 28 of the electronic actuator 14 but may in fact be located anywhere on the motor vehicle door 22 remote from the electronic actuator 14 if desired. Further, in some embodiments the active door edge guard system 10 may tap a secondary signal from an existing accelerometer mounted on the door 22 to function as a side door impact sensor of the motor vehicle safety system.

In either of these embodiments, the accelerometer 16 provides a signal to the controller 18 when the motor vehicle door 22 is being opened or closed. In response to that signal, the controller 18 activates the electronic actuator 14 to deploy or stow the door edge guard 12 as necessary to provide proper door function while protecting the edge 20 of the door from contact or impact with another object.

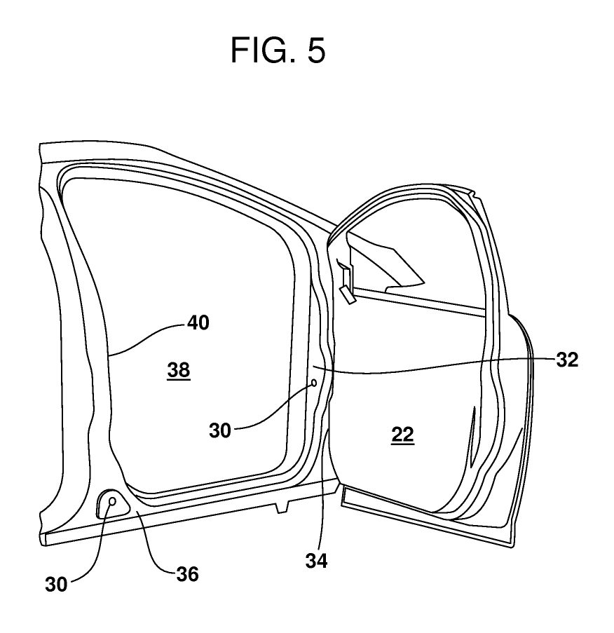

Reference is now made to FIG. 5 illustrating still another embodiment of the active door edge guard system 10. In this embodiment, the door motion sensor 16 comprises a plunger 30. As illustrated in FIG. 5, that plunger 30 may be carried on a body side structure 32 on the motor vehicle door sill at the hinge side 34 or in the lower sill 36 of the door opening 38 adjacent the latch side 40. In either location, when the motor vehicle door is closed, the plunger 30 is engaged. In contrast, when the motor vehicle door 22 is opened, the door disengages from the plunger 30. In either embodiment, an appropriate signal is then sent from the electronic plunger 30 through a control line to the controller 18 which then activates the electronic actuator 14 to stow or deploy the door edge guard 12 as necessary to provide proper door operation while simultaneously protecting the edge 20 of the door 22 in a manner described above.

As should be appreciated from the above, a method is also provided for protecting an edge 20 of a motor vehicle door 22 from damage due to contact/impact with another object when the door is opened. That method broadly comprises the steps of monitoring, by means of a door motion sensor 16, movement of the motor vehicle door 22 between closed and opened positions and activating, by means of the controller 18, an electronic actuator 14 for displacing the door edge guard 12 between the stowed position illustrated in FIG. 2A and the deployed position illustrated in FIG. 2B wherein that edge guard protects the edge 20 of the door 22 from contact/impact with any other object.

As illustrated in FIGS. 3A-3C, the method may also include the step of monitoring the door check assembly 24 of the motor vehicle door 22 to verify movement of the motor vehicle door between the closed and opened positions. As noted above, this may be done using a Hall effect sensor or a proximity sensor 16. In other embodiments, the method includes using an accelerometer 16 to monitor movement of the motor vehicle door 22 between closed and opened positions. Such an accelerometer 16 may be a dedicated accelerometer for the active door edge guard system 10. In other embodiments, the active door edge guard system 10 may utilize a secondary signal from an existing accelerometer 16 in the door 22 which functions as the side door impact sensor of the motor vehicle safety system. In still other embodiments, the method may include using a plunger 30 to monitor the movement of the motor vehicle door 22 between the closed and opened positions.

The foregoing has been presented for purposes of illustration and description. It is not intended to be exhaustive or to limit the embodiments to the precise form disclosed. Obvious modifications and variations are possible in light of the above teachings. For example, several different types of sensors 16 are listed above as embodiments for this concept. It may be advantageous to use more than one of these sensors to feed the controller 18 in order to achieve the best possible function. For instance, a plunger style switch 30 might be used to stimulate deployment of the door edge guard 12 but then a door check sensor 16 might be used to determine when to retract the door edge guard. In yet another embodiment, a plunger style switch 30 could be used to initiate the process within the controller 18 (e.g., re-establish a known door position or start a timer) and then an input from a door accelerometer 16 could be used to determine precisely when to deploy/retract the door edge guard 12 depending on how fast the door 22 is moving.

The door edge guard system 10 could also allow for customizable configuration. Some examples: a switch or menu pick in the vehicle could allow the driver to turn the function on/off. If the feature is available on all doors, perhaps the owner may choose to shut only some of them off. In conjunction with the vehicle GPS/Navigation system 22, the driver could perhaps choose to have the system 10 active only in certain locations (in their garage, known parking lots, within city limits, etc.). In conjunction with vehicle cameras, the driver could decide to shut the system off if the cameras do not detect something close enough to the vehicle to be a potential hazard. If there is something close enough to be considered a hazard, the controller 18 would remain activated and the chosen sensor(s) 16 and controller logic would be used to determine when to deploy/retract the guard 12. If the cameras see that you are parked in a field with nothing around, the controller 18 would be shut off and the guard 12 would not deploy when the door 22 is opened. All such modifications and variations are within the scope of the appended claims when interpreted in accordance with the breadth to which they are fairly, legally and equitably entitled.

1. An active door edge guard system for a motor vehicle, comprising:
a rigid door edge guard;
an electronic actuator for displacing said door edge guard between a stowed position and a deployed position;
a door motion sensor; and
a controller responsive to said door motion sensor to activate said electronic actuator as needed to protect an edge of a motor vehicle door.

2. The active door edge guard system of claim 1 wherein said door motion sensor is a Hall effect sensor.

3. The active door edge guard system of claim 2, wherein said Hall effect sensor is carried on said motor vehicle door and monitors a door check assembly of said motor vehicle door.

4. The active door edge guard system of claim 1, wherein said door motion sensor is a proximity sensor that monitors a door check assembly for said motor vehicle door.

5. The active door edge guard system of claim 1, wherein said door motion sensor is a dedicated accelerometer carried on said motor vehicle door.

6. The active door edge guard system of claim 5, wherein said electronic actuator includes a housing and said dedicated accelerometer is carried on said housing.

7. The active door edge guard system of claim 1, wherein said door motion sensor is an existing side door impact sensor of a motor vehicle safety system.

8. The active door edge guard system of claim 1, wherein said door motion sensor is a door ajar sensor.

9. The active door edge guard system of claim 8, wherein said door ajar sensor includes a plunger.

10. The active door edge guard system of claim 1, wherein said controller is configured to activate said electronic actuator to deploy said door edge guard as said motor vehicle door is opened and stow said door edge guard as said motor vehicle door is closed.

11. The active door edge guard system of claim 1, wherein said controller is configured to provide a time delay between the moment of receiving a door open signal and the activation of the actuator to displace the door edge guard into said deployed position.

12. A method protecting an edge of a motor vehicle door from damage due to contact/impact with another object when opened, comprising:
monitoring, by door motion sensor, movement of said motor vehicle door between closed and opened positions; and
activating, by controller, an electronic actuator for displacing a door edge guard between a stowed position and a deployed position protecting said edge of said motor vehicle door.

13. The method of claim 12 including monitoring a door check assembly of said motor vehicle door to verify movement of said motor vehicle door between said closed and opened positions.

14. The method of claim 12 including using a Hall effect sensor to monitor movement of said motor vehicle door between said closed and opened positions.

15. The method of claim 12 including using an accelerometer to monitor movement of said motor vehicle door between said closed and opened positions.

16. The method of claim 12, including using a plunger to monitor movement of said motor vehicle door between said closed and opened positions.
